(19) United States
(12) Patent Application Publication
(10) Pub. No.: US 2006/0254047 A1
(43) Pub. Date: Nov. 16, 2006

(54) Supply plate for an electrochemical system

(76) Inventors: Raimund Stroebel, Ulm (DE); Bernd Gaugler, Ulm (DE); Dominique Tasch, Neu-Ulm (DE); Kurt Hohe, Langenau (DE)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 11/410,708

(22) Filed: Apr. 25, 2006

(30) Foreign Application Priority Data
Apr. 26, 2005 (DE) 10 2005 020 332.9

(51) Int. Cl. H01M 6/00

(52) U.S. Cl. 29/623.2

(57) ABSTRACT

The present invention relates to supply plate (1), a base plate for the assembly of such a supply plate, as well as a method for manufacturing a supply plate for electrochemical systems. Two base plates (2a, 2b) are thermally joined to one another using a joining agent, wherein this joining agent (3) has a lower melting point than the material of the base plates (2a, 2b). At least one first base plate (2a) comprises at least one pocket (4a) into which joining agent is filled, and subsequently the second base plate (2b) is applied onto a joining plane (F) of the first plate, and a connection of the base plates (2a, 2b) is effected by way of the impact of heat on the joining agent.

The present invention relates to a supply plate for electrochemical systems, to a method for manufacturing the supply plate, as well as one or various plates for the assembly of a supply plate. Electrochemical systems thereby may for example be a fuel cell system or an electrochemical compressor system.

Electrochemical compressors systems may e.g. be electrolysers which by way of applying a potential, apart from the production of e.g. hydrogen and oxygen from water, simultaneously compress these gases under a high pressure.

Apart from this, electrochemical compressor systems such as e.g. electrochemical hydrogen compressors are known, to which gaseous molecular hydrogen is supplied, which is electrochemically compressed by applying a potential. This electrochemical compressing in particular lends itself for low quantities of hydrogen to be compressed, since a mechanical compression of the hydrogen here would require significantly more effort.

Electrochemical systems are known, with which an electrochemical cell stack is assembled with a layering of several electrochemical cells, which in each case are separated by bipolar plates. The bipolar plates hereby have several tasks:
electrical contacting of the electrodes of the individual electrochemical cells and the conduction of the current to the adjacent cell (series connection of the cells),
supply of the cells with reactants such as e.g. water or gases and e.g. the removal of the produced reaction gas via a suitable distribution structure,
transfering the waste heat caused by the electrochemical reaction in the cell, as well as
sealing the various media- and cooling channels mutually and to the outside.

For the supply and removal of the media from the bipolar plates to the actual electrochemical cells (these are e.g. MEAs (membrane electrode assemblies) with a gas diffusion layer (e.g. of a grahite non-woven) in each case orientated towards the bipolar plates, the bipolar plates comprise openings for cooling and for the supply and removal of media.

In particular here, single- or multi-part supply plates of metal are suitable for the inexpensive manufacture of supply plates on an industrial scale.

Multi-part supply plates, in particular two-part bipolar plates are usually embossed in two parts and these two parts are subsequently soldered to one another. The cavity arising between the two halves thereby serves as a cavity for leading through coolant, with which the operating temperature of the electrochemical system may be regulated. With trials of soldered metallic bipolar plates, one noticed that solder got into this cavity and may even block it. Furthermore, the disadvantage with the previous soldering methods is the fact that relatively high energy costs are required for this, and the solder has a relatively high mass, so that the power density of the electrochemical system is reduced. It may also be said that the required solder is usually subjected to the coolant, may corrode and thus may even increase the electrical conductivity of the coolant and thus reduces the power and life duration of the electrochemical system.

Proceeding from this state of the art, it is the object of the present invention to create a supply plate for electrochemical systems as well as a method for manufacturing such a supply plate, which has a large life duration, low electrical power losses as well as a high power density, and which may furthermore be manufactured inexpensively.

First and foremost, it is the case of a method according to the invention, for the manufacture of a supply plate for electrochemical systems, wherein two base plates, amid the use of a joining agent, are thermally (thus amid the application of thermal energy) connected to one another, and wherein this joining agent has a lower melting point than the material of the base plates, wherein at least one first base plate contains at least one pocket, into which joining agent is introduced, and subsequently the second base plate is applied onto a joining plane of the first plate, and a connection of the base plates is effected by way of the impact of heat on the joining agent.

Thus a supply plate with two base plates connected to one another arises by way of this, wherein these base plates enclose a region for the leading of fluid which is enclosed between the base plates, and wherein contact locations are provided within the region for the fluid leading, which are designed as pockets filled with solder for the connection of the base plates.

This method for manufacturing a supply plate according to the invention may thus be carried out with common technical means.

The pockets for accommodating the solder are hereby manufacturable together with the base plates in a single step, or may be manufactured in a preceding or subsequent step.

Basically, the pockets (or the base plates) may be manufactured with a forming method, for example embossing, forging or deep drawing. Alternatively, other methods are possible, for example etching methods. These options for manufacture apply to all embodiments in the present application, and this is the case not only for the pockets, but also for the manufacture of channel structures or also the manufacture of the solder receiver spaces adjacent to the pockets.

It is very advantageous that the quantity of introduced solder is minimised, in order thus to save costs and weight, and to optimise the power density. On determining the contact resistances of the supply plate according to the invention, it was even noticed that it is sufficient to have a metallic connection between the base plates only partially at a few contact locations, so that no increased passage resistance is given on account of this solder minimisation arising on account of only partial solder locations. This partial soldering thus also leads to the fact that less contact between the coolant and the solder is given. This in turn is advantageous for the corrosion properties. The invention thus contributes to an increase of the life duration of metallic supply plates/bipolar plates, and permits the application of more economical coolants by way of the minimal contact surface. Furthermore, the costs of solder material are reduced by way of the partial introduction of solder, and this also applies to the energy costs, since a soldering is only required in the regions in which one indeed must solder. The weight saving is also particularly important, which entails a high power density of the electrochemical system. Due to the fact that the solder is no longer necessarily located between flat sections of the plates (but in the pockets envisaged for it) one prevents the “capillary gap”. Finally, the absent capillary gap means a lower thickness of the joined electrochemical system, so that the power density here may be kept extremely low with respect to the volume.

It is particularly advantageous that the soldering, when joining the base plates which consist of different materials (titanium on the one hand and stainless steel on the other hand), is advantageous compared to welding methods, since thus a good sealing without deformation of the base plate is rendered possible.

Advantageous further formations of the present invention are specified in the depend claims.

One advantageous further formation of the manufacturing method envisages the heat effect being effected by laser soldering, vacuum soldering, diffusion soldering, reducing soldering, flame soldering in a run-through, or microwave-stabilised plasma welding. This shows that the invention may be realised with common soldering methods. Various soldering methods may be applied here, depending on the material parameters or the desired accuracy.

One further advantageous formation envisages the material of the joining agent being hard solder or lead-free soft solder, preferably a solder based on nickel, with a weight of more that 50% by weight of nickel being applied.

Several methods are also possible with the introduction of the joining agent, for example screen printing, pad printing, dispenser methods (CIPG) or also micro-spraying (ink-jet printing).

Different variants are also possible for the geometrical arrangement of the pockets. It is thus possible for pockets to be provided e.g. on only one base plate or also on both base plates, wherein these pockets may be designed independently of one another and/or complementarily to one another, see FIG. 8. In particular, by way of the complementary embodiments, one may yet achieve an additional positive fit of the base plates here (thus when two pockets engage into one another). This then furthermore increases the stability of the arising supply plate. Of course, pockets of the base plate which are partly complementary and are partly independent of one another, or also pockets which lie opposite, but are not arranged with a positive fit to one another, may also be prepared within a single supply plate.

One further advantageous formation envisages the pockets being designed as a continuous line or also as individual islands. Here, a continuous line for manufacturing a sealing function is necessary or makes sense. Individual or discrete islands serve for increasing the mechanical stability of the supply plate (protection from “bloating”). Furthermore, with these islands, one may also accordingly reduces the passage resistance with these islands, or even achieve a targeted turbulence of coolant in the electrochemical region.

Hereby, various methods, as discussed previously, are possible for the manufacture of the pockets. It is thus possible for example to manufacture the pockets in a forming method together with the embossing of the usual channel structures. It is however also possible to carry out embossing only on one side of one or both base plates, for example with a forging or etching method. Then no raised part on the respective rear side of the corresponding base plate results.

One further advantageous formation envisages the cross-sectional shape of the pockets in the joining plate being rectangular, oval, circular, semicircular or triangular. Here, the selection of the shape may be effected depending on the desired stability or the desired contact surface or also according to the desired effect with regard to fluid mechanical behavior.

One further advantageous formation envisages the cross-sectional shape of the pockets perpendicular to the joining plane being triangular, semicircular or rectangular. “Joining plane” here is to be understood as the “ideal line” between two base plates, thus their gap-free contact plane (see joining plate “F” in the particular description part).

One further advantageous formation envisages the pocket depth, proceeding from the joining plane being maximally 1-500 μm, preferably 5-200 μm, particularly preferably 10-60 μm. With regard to this, it is to be noted that only relatively low pocket depths and thus relatively low quantities of solder are necessary in order to achieve the desired bond according to the invention, between the two base plates.

One further advantageous formation envisages the ratio of the maximal pocket depth, proceeding from the joining plane, to the maximal depth of the channel structure embossed into the base plate (likewise proceeding form the joining plane), being between 1:1.5 ad 1:25. By way of this too, it is also once again made clear that the pockets only require a relatively low depth compared to the embossed channel structure, in order to fulfill their function here.

One further advantageous formation envisages the ratio of the maximal pocket depth, proceeding from the joining plane, to the average material thickness of the base plate in the pocket-free or channel-structure-free electrochemically active region of the base plate lying between 1:1.5 and 1:10. The length of the pockets in the joining plane here is maximally 100 mm, preferably 0.2-100 mm, particularly preferably 0.5-20 mm. The corresponding width of the pockets is 0.1-200 mm, preferably 0.2-5 mm, particularly preferably 0.3-1.5 mm. The corresponding ratio of the width of the pocket to the length of the pocket thereby should preferably be larger than 1:100 and smaller than 1:1. By way of this, it is clear that a size adaptation of the respective pocket according to the field of application may be accomplished within wide limits. If need be, in particular in the region of sealing seams, it is also possible to provide larger lengths, and alternatively sealing seams may of course also be manufactured with other methods, for example laser welding.

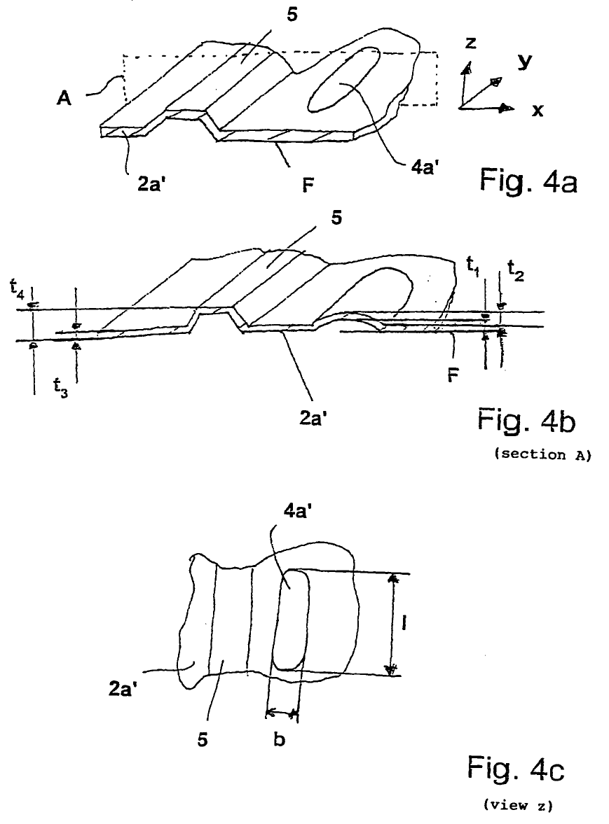

One further advantageous formation envisages the base plates on the side of the base plate which is distanced to the joining plane comprising raised parts in the region of the pockets. This is usually e.g. the case with pockets manufactured in the forming method. However, a flow influencing on the side of the base plate distant to the joining plane also results on account of this, which under certain circumstances may be undesirable, so that the forging or etching method are then somewhat more suitable, since these display no raised parts on the side distant to the joining plane and thus no influencing of the flow field there. The highest raised part, measured from the plane on which the side of the base plate distant to the joining plane, thereby should be maximally 1:1.5 to 1:25, with respect to the channel depth (see t₁ in FIG. 4b).

The pockets are preferably arranged in the electrochemically active region of the supply plate, since this may essentially coincide with the region of the cavity for receiving the coolant, or an electrical contacting in the region of the joining agent locations is useful in this region, in order to accordingly reduce the contact resistance.

One further advantageous formation envisages solder being used as a joining agent, and for the corresponding method to be laser soldering by way of a laser beam which operates guided on an axis or assisted by scanner, to be effected as a corresponding method. In this manner, a supply plate according to the invention may be manufactured very precisely and in a short time.

One further advantageous formation envisages providing means which prevent or limit the flowing-out of the joining agent from the pocket. This in practice may be useful since with two base plates which are applied onto one another, of which one comprises pockets which are filled with joining agent (solder), this solder becomes liquid on heating and as a result of the capillary effect enters into the (theoretically undesirable but technologically hardly avoidable) gap between the two base plates, and thus a flow of solder into undesired regions is effected. Various measures are conceivable as a means for limiting the solder flow. On the one hand, it is possible to peripherally introduce so-called solder resist around the pockets or also a suitable solder limitation film. It is particularly advantageous to provide further, small solder receiver spaces around the pocket, into which the solder flowing away out of the pocket may flow. A pressure drop then exists on account of the size of these solder receiver spaces, so that the solder no longer distributes in the surface plane.

One further advantageous formation envisages the supply plate being a bipolar plate for polymer electrolyte membrane fuel cells (PEMFC). Basically, the invention however may be applied to all supply plates of electrochemical systems. Thus one may apply it for example also to direct methanol fuel cells (DEMFC) and solid oxide fuel cells (SOFC). The application in electrolysers, hydrogen compressors as well as further types of electrochemical systems is also possible.

Further advantageous formations are specified in the remaining dependent claims.

The invention is now explained by way of several figures. There are shown in:

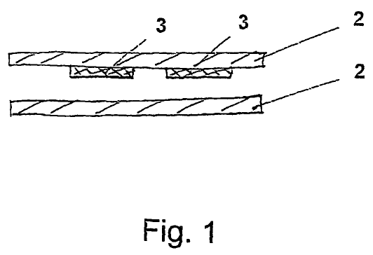

FIG. 1 a assembly of a supply plate according to the state of the art;

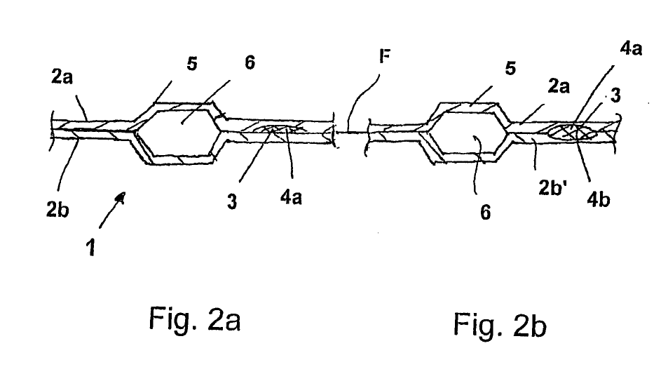

FIGS. 2a and 2b supply plates according to the invention with forged or etched solder pockets;

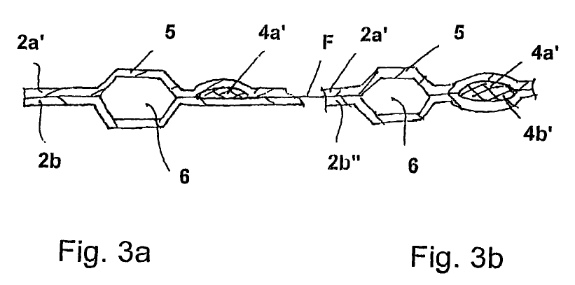

FIGS. 3a and 3b supply plates according to the invention with formed solder pockets;

FIGS. 4a to 4c a detailed view of a pocket according to FIG. 3a, in several views;

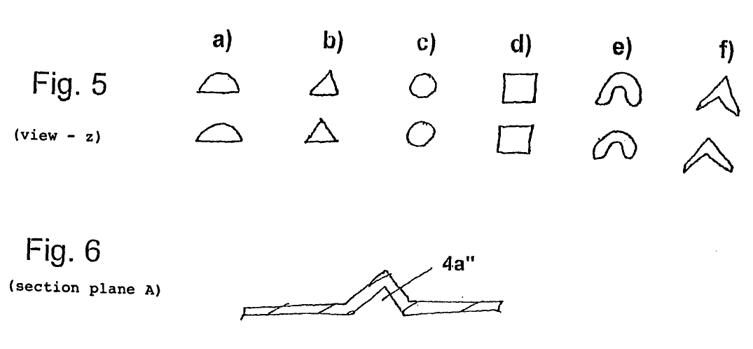

FIG. 5 various geometries of pockets in the joining plane of the supply plates as well as

FIG. 6 a cross-sectional view of an alternative pocket;

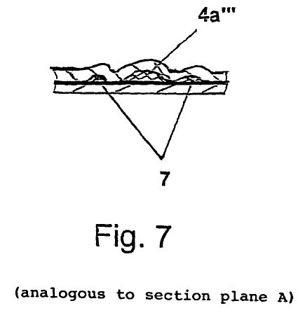

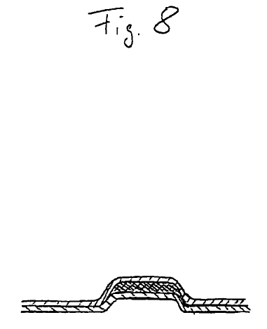

FIG. 7 pocket with solder-receiving spaces;

FIG. 8 a cross-sectional view of pockets which regionally engage into one another with a positive fit.

FIG. 1 shows a metallic bipolar plate according to the state of the art with which two-dimensional joining agent 3 is deposited onto an upper plate 2 and subsequently (for example by way of vacuum soldering) the joining agent 3 is made to melt, and a soldered supply plate arises after pressing together the two plates 2 and curing the joining agent.

FIG. 2a shows a supply plate 1 according to the invention. This comprises a first base plate 2a as well as a second base plate 2b. The supply plate 1 furthermore comprises embossed channel structures 5 which enclose a cavity in which a cooling fluid 6, for example distilled water, is held for regulating the temperature. The supply plate is part of a layering of an electrochemical system, mainly a fuel cell system. The base plates 2a and 2b of the supply plate 1 are joined to one another in a joining plane F. This joining plane is to be assumed as having no gap. The first base plate and the second base plate thus lie on one another in a gap-free manner in this joining plane.

The joining plane need not be an ideal geometric plane, in particular steps etc. are possible in the edge region between the first and the second base plate The course of the contact surfaces are however accordingly also to be understood as a “joining plane” here.

The first base plate 2a contains a pocket 4a in which joining agent is attached. This joining agent 3 is hardened and connects the first base plate 2a as well as the second base plate 2b with a material fit.

This base plate 2a as well as the second base plate 2b are of metal, specifically non-rusting stainless steel (for example Cr—Ni— steels, e.g. 1.4404; preferably steels with a chrome component of >14% by weight and a nickel component of <30% by weight, or also alloys based on nickel, or titanium- or aluminum alloys are also possible). Preferably hard solder or lead-free soft solder may be used as a material for the joining agent 3. Mainly a solder based on nickel with a 60% part by weight of nickel is given. The pocket 4a in the section shown in FIG. 2a has a semi-oval shape. An oval shape is given in the joining plane (thus perpendicular to the sheet of the plane). The pocket 4a here has been manufactured in a forging method after/before or simultaneously with the manufacture of the channel structure 5 (effected in a forming press), so that no raised part is to be seen on the side of the first base plate which is distant to the joining plane. With regard to the present supply plate, which is designed as a bipolar plate, the channel structure 5 is arranged in an electrochemically active region of the bipolar plate/supply plate. Here the fuel, e.g. molecular hydrogen, flows above the first base plate 2a, and the oxidant, e.g. molecular oxygen or air, flows below the second base plate 2b.

The manufacturing method of the supply plate for electrochemical systems are described in the following by way of example.

Here, the two base plates 2a, 2b are thermally connected to one another using the joining agent 3, wherein the joining agent 3 has a lower melting point than the material of the base plates. The first base plate 2a contains at least one pocket 4a in which joining agent is filled. Subsequently, the second base plate 2b in the joining plane F is applied onto the first base plate and a connection of the base plates is created by way of the impact of heat on the joining agent.

Thereby, the heat effect is achieved by way of laser soldering. Here, a laser beam in an axially guided manner or with the help of a scanner according to a fixed programmed plan is led onto the corresponding location of the pockets (directed on the side distant to the joining plane) and a heating of the first and the second base plate and thus of the solder/joining agent lying therebetween is achieved. The joining agent was deposited prior to this into the pocket 4a of the first base plate by screen printing.

Thus in each case, at least one base plate for the assembly of a supply plate and for the use in a manufacturing method are thus shown in FIG. 2a (as well as the FIGS. 2b, 3a and 3b, 4a to 4c), wherein the base plate 2a and 2b comprises channel structures 5 projecting from the joining plane F, for leading a cooling fluid, and pockets for receiving joining agent are given between the channel structures.

Thus a supply plate 1 with two base plates which are connected to one another is accordingly disclosed, wherein these base plates enclose a region for leading fluid, enclosed between the base plates, wherein contact locations are provided within the region for leading the fluid, which are designed as pockets filled with joining agent, for the connection of the base plate.

FIG. 2b shows a further supply plate which in turn comprises a first base plate 2a as well as a second base plate 2b′ and which in contrast to the supply plate shown in FIG. 2a comprises a further pocket 4b which together with the pocket 4a forms a cavity which is completely filled with joining agent 3.

Further embodiments of supply plates are presented in the following. In order to prevent repetition, it is to be mentioned that that which has been said with regard to FIG. 2a and FIG. 2b applies to all of the subsequently explained supply plates. Only the different features will be explicitly dealt with hereinafter.

FIG. 3a shows a further embodiment of a supply plate, wherein here, a pocket shape which is different to FIG. 2a is given. The pocket 4a′ in FIG. 3a on a side of the first base plate 2a which is distant to the joining plane F has a raised part.

FIG. 3b corresponds essentially to FIG. 3a, wherein here again the pocket shape 4a′ and 4b′ on the first base plate 2a′ and the second base plate 2b″ respectively are shown, which on the side of the supply plate distant to the joining plane in each case comprise raised parts.

In the following, the geometric details of this supply plate or the pockets are explained by way of the first base plate 2a′ shown in FIG. 4a. Here, an X-Y-Z coordinate system has been introduced for a simplified representation.

The first base plate 2a shown in FIG. 4a is sectioned in a section plane A and the corresponding section is shown in FIG. 4b.

Accordingly, a view in a positive Z-direction (thus a view of FIG. 4a from below) is shown. From looking at FIGS. 4a to 4c together, it is to be seen that the pocket depth t₁, measured from the joining plane F (this coincides mainly with the X-Y-plane) is 50 μm. The ratio of the maximal pocket depth t₁ proceeding from the joining plane to the maximal depth t₄ of the channel structure embossed in the base plate, likewise proceeding from the joining plane F, here is 1:10. The ratio of the maximal pocket depth t₁ proceeding from the joining plane F to the average material thickness t₃ of the base plate in the electrochemically active region free of pockets and channel structures lies at 1:5. The ratio would be for example 1:2 with 50 μm pocket depth and a material thickness of 0.1 mm.

The length of the pocket 4a′ in the joining plane is (see also FIG. 4c) l=20 mm. The width b of the pocket 4a′ (see likewise 4c) is mainly 1 mm.

From the FIGS. 4a to 4c, it is to be seen that the pocket shown there has the shape of a “drawn-out oval” in the X-Y plane, and has a semi-oval or semicircular cross section in the X-Z section.

Alternative cross sectional shapes or plan views of pockets are specified in the FIGS. 5 and 6.

FIG. 5 shows alternative shapes of pockets which on the side of the first base plate 2a′ which is distant to the joining plane F are shown from FIG. 4a (thus a view from “above”, thus a view in the “negative” Z-direction).

Here, the variant a shows a semicircular view, the variant b a triangular view, variant c a round view, variant d a square view, variant e a boomerang-shaped view and variant f an arrow shaped shape with a “barb”. The pockets shapes may be incorporated rowed to one another parallel to a channel structure 5 (thus in the Y-direction). An additional influencing of the flow conditions on the flowfield located here may be achieved by these structures.

Finally FIG. 6 shows an alternative cross sectional shape of a pocket 4a″, likewise in the section plane A (thus in the X-Z-plane as is shown in FIG. 4a). Here it is not the case of a semi-oval or semicircular pocket, but of a pocket with a corresponding triangular cross section.

FIG. 7 shows a section through a supply plate according to the invention (analogous to the previously mentioned sections in the section plane A). Here, the upper base plate comprises a pocket 4a′″. Solder receiver spaces 7 are shown arranged around this pocket in the surface plane (either peripherally around the pocket in a coherent manner or in individual sections), in which solder exiting from the pocket 4a′″ by way of the capillary effect may be collected, in order thus to prevent a further spreading of the solder in the surface plane.

FIG. 8 shows the meshing of pockets, as a variant of a complementary embodiment. Here the lower plate with its pockets pointing upwards engages with a positive fit and in regions into the pocket of the upper plate which points upwards. The space existing between the plates or the pockets is filled with solder. The additional positive fit simplifies the centering and the manufacture.

1. A method for manufacturing a supply plate for electrochemical systems (1), wherein two base plates (2a, 2b) are thermally connected to one another using a joining agent (3), and wherein this joining agent (3) has a lower melting point than the material of the base plates (2a, 2b), characterized in that at least a first base plate (2a) contains at least one pocket (4a) in which joining agent is introduced, and subsequently the second base plate (2b) is applied onto a joining plane (7) of the first base plate (2a), and a connection of the base plates (2a, 2b) is effected by way of the impact of heat on the joining agent.

2-23. (canceled)
